(19) United States
(12) Patent Application Publication
(10) Pub. No.: US 2016/0366547 A1
(43) Pub. Date: Dec. 15, 2016

(54) LOCATING DEVICES BY CORRELATING TIME SERIES DATASETS

(71) Applicant: Microsoft Technology Licensing, LLC, Redmond, WA (US)

(72) Inventors: Stephen Edward Hodges, Cambridge (GB); James Scott, Cambridge (GB)

(21) Appl. No.: 14/739,212

(22) Filed: Jun. 15, 2015

(51) Int. Cl. H04W 4/02; H04W 52/02

(52) U.S. Cl. CPC H04W 4/02; H04W 52/0261

(57) ABSTRACT

A system for determining a location of a mobile device is described. The system comprises receives a first time series dataset and a second time series dataset. The first data time series dataset records dynamic events in an infrastructure and the second time series dataset records dynamic events experienced by a mobile device, as captured by a sensor in the mobile device. The system further comprises a correlation engine which determines the location of the mobile device by correlating two or more data points from the first dataset with two or more data points from the second dataset.

### BACKGROUND

Nearly all mobile telephones now include GPS capability which can be used to determine the location of the mobile telephone, and hence the location of the user who is carrying the mobile telephone (e.g. on their person or in a bag). This location data can then be used to provide location-based services to the user, such as navigation services, targeted information about local weather or amenities, etc. However, using the GPS functionality increases the energy consumption of the mobile telephone considerably and as a result it significantly shortens the length of time that the mobile telephone can operate without the battery being charged. Additionally there are some locations where GPS cannot be used to provide location information because the mobile telephone cannot receive signals from the required number of satellites.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A system for determining a location of a mobile device is described. The system comprises receives a first time series dataset and a second time series dataset. The first data time series dataset records dynamic events in an infrastructure and the second time series dataset records dynamic events experienced by a mobile device, as captured by a sensor in the mobile device. The system further comprises a correlation engine which determines the location of the mobile device by correlating two or more data points from the first dataset with two or more data points from the second dataset.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram showing a system for determining the location of a mobile device;

FIG. 2 is a flow diagram of the method of determining the location of a mobile device; and

FIG. 3 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, although GPS can be used to accurately locate a mobile telephone, its use dramatically increases the power consumption of the device and hence shortens the time that the device can operate without external power. This becomes even more significant for personal computing devices which are smaller and/or lighter than a mobile telephone (e.g. wearable computing devices) because their battery size (and hence capacity) is further constrained. Consequently, a user may disable the GPS functionality (e.g. except when they wish to perform a specific task such as navigation) in order to preserve battery life. There are also situations where GPS does not function well because of lack of sight of sufficient satellites (e.g. 3 or 4 satellites), such as indoors and in underground locations (e.g. subway tunnels, underground train systems, etc.). There are also some personal computing devices (e.g. some tablet computers, many portable games consoles and wearable computing devices) and many embedded devices (e.g. many IoT (Internet of Things) devices) which do not have GPS capability.

Instead of relying upon GPS, the location of a mobile telephone may alternatively be determined using localization methods which rely upon the wireless receiving of signals, such as WiFiTM base station fingerprinting or cell tower localization.

The embodiments described below are not limited to implementations which solve any or all of the disadvantages of known methods of determining location.

Described below is a method of locating a mobile device (e.g. a personal computing device or an IoT device), which does not rely upon use of GPS. As a result, this method may be used to locate a mobile device where there is no working GPS functionality (e.g. where it is not provided, disabled or is otherwise unable to work, such as due to lack of visibility of satellites). The method may also be used where there is working GPS functionality as an alternative, lower power, method of locating a mobile device and/or for applications running on the mobile device which are not authorized to access the GPS data. The method also does not rely on the detection of wireless signals from a base station or cell tower (such as in WiFiTM base station fingerprinting or cell tower localization).

In various examples, the mobile device may be a personal computing device or personal electronic device which is carried by a user. In such examples, the method described below may be used to locate the user carrying the personal computing or electronic device. The term ‘personal computing device’ is used herein to refer to any electronic device which has computing capability and which is worn or carried by a user (e.g. on their person, such as in a pocket or in their hand, or in a bag). It includes larger portable devices, such as tablet computers, as well as mobile telephones (which may also be referred to as smartphones), phablets, portable music players (e.g. MP3 players), portable games consoles and smaller devices, such as wearable computing devices (e.g. smart watches, fitness tracking wristbands, head-mounted displays, augmented reality devices, etc.). The term ‘personal electronic device’ is used to refer to any electronic device which is worn or carried by a user but does not include any computing capability.

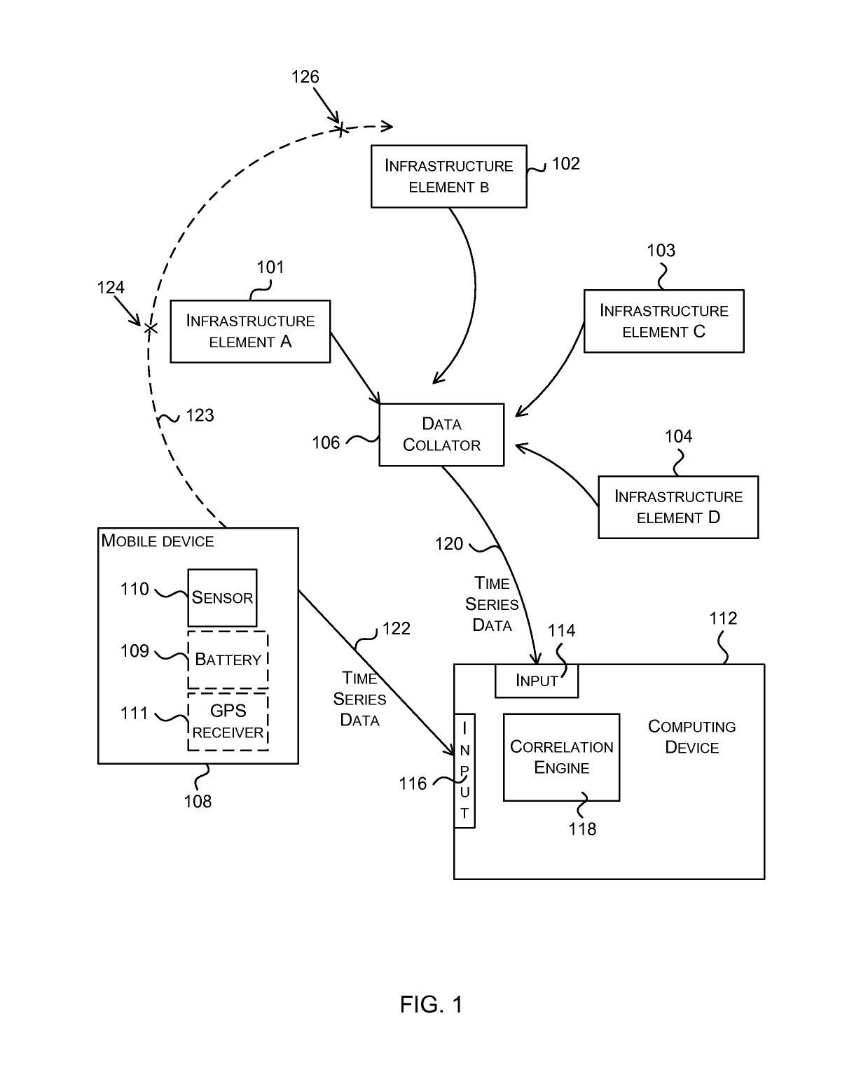

FIG. 1 is a schematic diagram showing an infrastructure which comprises one or more separate infrastructure elements and in the example shown the infrastructure comprises four infrastructure elements 101-104 (where these infrastructure elements may all be of the same type or may be of different types). The term ‘infrastructure’ refers to the basic physical systems of a society or business and examples include transportation, communication, sewage, water and electric systems which may, for example, be on a town/city scale or within a campus or building. The infrastructure generates a first time series dataset which records dynamic events within the infrastructure. For example, if the infrastructure is a traffic light system within a city (e.g. with each element 101-104 representing an individual traffic light or a set of traffic lights at a road intersection) the time series dataset records the actual times that the traffic lights change from green to red and vice versa (in contrast to a schedule, which is not a time series dataset which records dynamic events but may instead be a dataset which describes a planned traffic light pattern). In many infrastructure examples, there may be a planned schedule/pattern (e.g. of traffic lights, underground trains or buses) but the actual infrastructure may not follow this exactly due to human intervention (e.g. a pedestrian pressing the button to cross a road) or human interaction (e.g. delays in train schedules caused by people boarding the train slowly or pressing passenger alarms) or other external factors (e.g. the weather, an offset between clocks in the system, etc.).

The data points in first time series dataset (each of which includes a timestamp) may be generated at the individual infrastructure elements 101-104 (e.g. based on sensors in each individual infrastructure element) or may be generated at a central point (e.g. data collator 106) within the infrastructure based on data received from each individual infrastructure element 101-104. Where the data points in the first time series dataset are generated at the individual infrastructure elements 101-104, the data points may be collated within the infrastructure (e.g. by data collator 106, as shown in FIG. 1) or alternatively, each infrastructure element 101-104 may generate its own time series dataset that records dynamic events at that infrastructure element, with these separate time series datasets being subsets of the first time series dataset.

FIG. 1 also shows a mobile device 108 which comprises a sensor 110 (and which may be a personal computing device or personal electronic device). The mobile device 108 generates a second time series dataset which records dynamic events detected at the mobile device 108. These dynamic events are detected using the sensor 110 in the mobile device 108 and again each data point includes a timestamp). The sensor 110 may be of any type and examples include, but are not limited to, an accelerometer, a light sensor, a microphone, a barometer, a temperature sensor, a humidity sensor, a spectrograph, a camera and a magnetometer. The mobile device 108 may also comprise a battery 109 and in some examples further comprises a GPS receiver 111.

FIG. 1 also shows a system for determining the location of the mobile device (and hence also of a user in examples where the mobile device is carried by the user), which in this example is implemented by a separate computing device 112. In other examples, however, the system for determining the location of a mobile device may be implemented by the mobile device 108 or may be implemented across multiple devices (e.g. with some functionality being implemented on the mobile device 108 and other functionality being implemented on the separate computing device 112). The system (and hence computing device 112 in this example) comprises a first input 114 for receiving the first time series dataset and a second input 116 for receiving the second time series dataset and in some examples, a single input may acts as both the first and second inputs and receive both the first and the second time series datasets. The computing device 112 may, for example, be a shared computing device in a data center (e.g. a ‘cloud computer’) or a user's personal computing device (e.g. a desktop, laptop or tablet computer or a games console). The system further comprises a correlation engine 118 which correlates two or more data points in the first dataset with the same number of data points in the second dataset to determine the location of the mobile device.

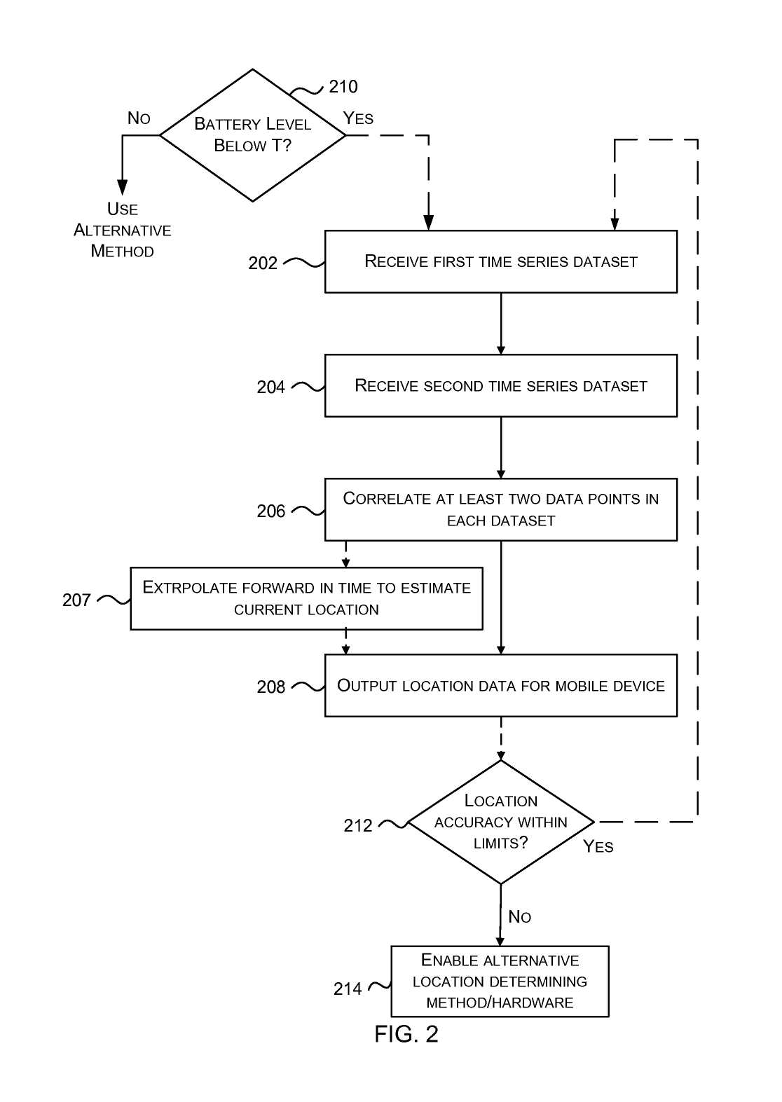

FIG. 2 is a flow diagram showing the operation of the system (e.g. computing device 112) which can be described with reference to FIG. 1. The system receives a first time series dataset (block 202, arrow 120) via a first input 114, where, as described above, the first time series dataset records dynamic events within the infrastructure. The first time series dataset comprises a plurality of data points, each data point comprising a timestamped data value, where this data value may be a measurement (e.g. sensor data generated by a sensor in an infrastructure element) or a state identifier (e.g. identifying a current state of the infrastructure element, such as on or off, red or green, moving or stationary, etc.) and where each data point relates to (and may have been generated by) one of the one or more infrastructure elements 101-104.

In the example shown in FIG. 1, the first time series dataset is received from a single data collator 106 within the infrastructure, but in other examples, timestamped data points which form the first data series may be received from the individual infrastructure elements 101-104 and collated by the system (e.g. the data collator 106 function may be part of the system which determines the location of the user instead of being part of the infrastructure). In other examples, there may be more than one data collator within the infrastructure and the system may receive data streams comprising data points which are part of the first time series dataset from one or more data collators.

Each of the data points in the first time series dataset may include information identifying which infrastructure element the data point corresponds to (where there is more than one infrastructure element) as this identifies the location of the dynamic event and may, in some examples, also identify where the data point was generated. This identifying information may comprise location information (i.e. the location of the corresponding infrastructure element e.g. as defined using latitude and longitude) or an identifier for the infrastructure element (e.g. infrastructure element A, 101) and the system may (optionally) receive location information describing the layout of the infrastructure separately.

For example, each of the data points in the first time series dataset may include only an identifier (e.g. of the infrastructure element), a timestamp and some event related data (e.g. which identifies what the dynamic event was). The identifier may be used to look up a location in a separate process (which may, in some examples, happen offline/later). The location may be absolute coordinates (e.g. latitude and longitude), a relative position (e.g. the third train station along a train line) or a named location (e.g. where the name does not by itself form a Euclidean space, i.e. where distance between named places is known, although the name could be correlated with a geographic location which does have such properties).

The system also receives a second time series dataset (block 204, arrow 122) via a second input 116, where, as described above the second time series dataset records dynamic events detected at the mobile device 108 (and hence, where the mobile device 108 is carried by a user, the second time series dataset records dynamic events in the vicinity of the user which can be inferred from sensor information, and so dependent upon the sensed quantity, may record dynamic events experienced by the user who is carrying the mobile device 108). The second time series dataset comprises a plurality of data points, each data point comprising a timestamped sensor data value or a timestamped value derived from the sensor data, where the sensor data is generated by the sensor 110 in the mobile device. The data points in the second time series dataset do not include any location information (i.e. no GPS location information, cell site information or access point information), although they may include an indication that they were generated by the mobile device 108 (e.g. to distinguish the dataset from one generated by a different mobile device 108 which may, for example, be being carried by a different user).

The correlation engine 118 correlates at least two data points from each dataset (block 206) to identify a location (e.g. a single position in space) or a location path (e.g. a series of positions) of the mobile device (and hence in some examples also of the user who is carrying the mobile device 108). The correlation which is performed (in block 206) may be performed soon after the data points in the datasets are generated or may be performed later (e.g. when a user returns home with their mobile device).

In various examples a particle or Kalman filter may be used for combining the correlation across multiple events to narrow down the space. For example, if the sensor in the mobile device detects that motion has stopped at a particular time, the correlation engine 118 or computing device performing the correlation may query the infrastructure data and discover that three trains stopped at that time (e.g. within a particular time window based on the accuracy window of the data, e.g. due to clock synchronization issues, network latency, etc.). When the sensor in the mobile device detects that motion has started, it may discover that two of the three trains left a station at that time and so the search space is narrowed down to two trains. At the next station, the stop detected by the mobile device may correlate with 4 trains; however, only one of these is in the previously identified set of two trains. A pure correlation would determine that the mobile device might be on either of those two trains now; but a system using knowledge of the possible movement patterns can exclude the false one. Whilst this is a simple example (because the motion is constrained to a train line), particle filters and Kalman filters can be used in more complex situations where the movement is not constrained along a particular network.

Having identified the location (or location path), this is output (block 208) and may be presented to the user (e.g. in a graphical user interface) or used by an application or service which may be running on the mobile device 108, the computing device 112 or a further computing device (not shown in FIG. 1) to provide location-based services. In an example, the location information (output in block 208) may be used to infer that two users are in proximity to each other (e.g. both is close to a particular infrastructure element) or are travelling on similar journeys (e.g. as their location paths match or are very similar) and consequently location-based services such as nearby friend finding or peer-to-peer gaming may be enabled. The location information may also be used in other ways. For example, where two users are identified as travelling on similar journeys, this information may be used by the correlation engine 118 to assist in determining further location information (e.g. to assist in extrapolating forward in time to determine a current location).

The location which is output (in block 208) may be the location which is identified using the correlation process (in block 206) or in various examples, the location which is output may be determined by extrapolating forward from a last known event (block 207) e.g. from the location corresponding to the last pair of matching data points. The extrapolation (in block 207) may be based on historical data, a schedule and/or on data from one or more sensors, where these sensors may be the same as the sensor 110 used to generate the second dataset or may be different sensors (e.g. if a magnetometer indicated that no turns were made, it may be assumed that the mobile device continued in a straight line from the last known ‘go’ event). Where sensor data is used in the extrapolation (in block 207), the sensors generating the sensor data may record/estimate real-world motion and examples of suitable sensors include, by are not limited to, magnetometers, gyroscopes, accelerometers and barometric sensors.

Referring to the example shown in FIG. 1, if the mobile device 108 moves along the path indicated by the dotted arrow 123, the second time series dataset may include a data point (t₁,s₁) generated at time t₁ and where S₁ is the sensor data value at time t₁ or a value derived from the sensor data at time t₁. The second time series dataset may also include a second data point (t₂,s₂) generated at time t₂ and where s₂ is the sensor data value at time t₂ or a value derived from the sensor data at time t₂. The sensor values may, for example, indicate that the user stopped moving at times t₁ and t₂. As described above, the data points do not include any location information.

Independently and in parallel, the infrastructure (e.g. elements 101-104) generate the first time series dataset which describes dynamic events within the infrastructure and where there are multiple infrastructure elements, there may be more than one data point in the first time series dataset with the same timestamp. In an example, the first time series dataset may include three data points: (t₁,d_{1A}, A), (t₁,d_{1D}, D), and (t₂,d_{2B}, B) where t₁ and t₂ are timestamps, d_{1A}, d_{1D} and d_{1B} are data values (e.g. a measurement or state identifier) relating to the infrastructure elements A, D and B respectively.

The correlation engine 118 may receive these two time series datasets and correlate (in block 208) the two data points (t₁,s₁) and (t₂,s₂) in the second time series dataset with data points (t₁,d_{1A}, A) and (t₂,d_{2B}, B) in the first time series dataset. As described above, the correlation engine correlates two or more data points and in this example it may first correlate a first data point (t₁,s₁) from the second dataset with two data points (t₁,d_{1A}, A) and (t₁,d_{1D}, D) in the first dataset based upon the timestamps. The correlation engine may then correlate a second data point (t₂,s₂) from the second dataset with a data point (t₂,d_{2B}, B) in the first dataset based upon the timestamps. Using knowledge of the locations of the particular infrastructure elements, a Kalman or particle filter within the correlation engine 118 or within the computing device comprising the correlation engine 118 may then determine that if the mobile device was at location D at time t₁ it could not then be at location B at time t₂ (e.g. because they are too far apart or because a train or bus route does not go from D to B) and consequently, the system may output a location path including the locations of infrastructure element A 101 and infrastructure element B 102 or a single location e.g. the location of infrastructure element B 102 or a location extrapolated based on the location path and the time since the user was proximate to infrastructure element B 102, t₂.

The two time series datasets described above are generated by different entities (the first is generated by the infrastructure and the second by a mobile device) and detect different physical phenomena, even though in some examples the same type of sensor may be used in generating both datasets. The first dataset relates to an aspect/parameter/state of the infrastructure, such as whether a traffic light is red or green or whether a light is on or off, or whether a bus is moving or stationary (where in this example, the bus is the infrastructure element). The second dataset relates to sensor data measured by the mobile device and so relates to the mobile device's immediate environment. In examples where the mobile device is being carried by a user and the sensor data (and hence the second dataset) relates to the user's experience (e.g. the user's immediate environment).

In one example, the first dataset may record the state of traffic lights (e.g. red/green) and the second dataset may comprise accelerometer data from an accelerometer (sensor 110) within the mobile device and hence record the motion of the mobile device. Again, if the mobile device is being carried by a user, the second dataset may record the motion of the user (who may be walking or in a vehicle).

In another example in which the two datasets are generated using the same type of sensor, a light switch (which is an infrastructure element) may be implemented using a proximity sensor and the first dataset may record when the light switches (e.g. within a building) are switched on and off The second dataset may comprise light sensor data from a light sensor (sensor 110) within the mobile device. By correlating changes in light sensor data (as captured in the second dataset) with when light switches are activated (i.e. switched on or off), the location of the mobile device within the building can be determined. If the proximity sensor is implemented using a light emitter and a light detector, both datasets are generated using the same type of sensor (i.e. a light detector) however they detect different physical phenomena: the light sensor in the proximity sensor (which generates the first dataset) senses light emitted by the light emitter in the proximity sensor and bounced off a nearby hand, whereas the light sensor in the mobile device (which generates the second dataset) senses the ambient light level in the room, where this ambient light level may be the result of a light controlled by the light switch in combination with any external light sources, such as the sun and lights in adjacent and connected rooms (e.g. connected by a door, window or other opening). Various implementation examples are described in more detail below.

The data points within the first and/or second time series dataset may be generated at fixed time intervals (e.g. one data point every 10 seconds) and hence will be regularly spaced in time. Alternatively, the data points within the first and/or second time series dataset may be generated based on criteria associated with the sensor data or state, such that, for example, a data point is generated when the state of the infrastructure changes (e.g. when a traffic light changes between red and green) or when the sensor data value exceeds a threshold (e.g. when the output of an accelerometer in the mobile device exceeds a pre-defined amount). The correlation may, therefore, be performed between two datasets where the data points in each data set always coincide temporally or where the data points in the two datasets may often, occasionally or never contain matching timestamps.

Although the example correlation described above showed the correlation between data points with matching timestamps (e.g. t₁), in other examples, the correlation may use a mapping between the datasets which may be specific to the physical phenomena being detected/captured by the two datasets (e.g. an application-specific mapping). This mapping may result in an offset in the timestamps (e.g. when correlating the data points, an offset may be applied to one of the timestamps, such that a timestamp in the first dataset of t₁ maps to a timestamp of t₁+Δ, in the second dataset) and/or locations (e.g. if the correlation identifies that a data point in the second dataset corresponds to a data point generated by infrastructure element A 101, the location of the mobile device, at the time given by the timestamp or offset from that timestamp, may be offset from the location of the infrastructure element A). An offset is just one example manifestation of the mapping which may, in addition or instead, involve use of a known error bound (e.g. when a mobile device is nominally at infrastructure element A 101, because a point in the second dataset correlates with a point in the first dataset corresponding to infrastructure element A, the device may be within a certain range of that position, where this range encompasses the location indicated by arrow 124, and similarly for infrastructure element B 102 and the location indicated by arrow 126) or quantization (e.g. where, as described above, data points in one or both of the datasets are generated at fixed time intervals).

In an example, the first dataset is records when traffic lights change color and the second dataset records accelerometer data from an accelerometer in the mobile device which may be carried in a vehicle or by a user who is in a vehicle. Encountering a red light can change behavior in multiple ways. If the mobile device is in the first vehicle to stop in a stream of traffic, then the stopping (as recorded in the second dataset) may correlate closely in time and position with the light turning red (as recorded in the first dataset). If the vehicle approaches the light later, then it may stop at any point before the light becomes green again (and maybe even afterwards, if the traffic queue is long) and this causes the stop event to be offset from the light-red event, and the go event to be offset in time from the light-green event. Furthermore the positions can be offset—in the case of the green/go correlated events, the delay between the green and the go can be used to estimate the distance the vehicle (and hence the mobile device in the vehicle) was behind the traffic light when it stopped. If the vehicle queues behind the same red light through multiple transitions (e.g. when the light goes green they advance in the queue but do not reach the traffic light before the light goes red again), then analysis of the datasets would see the stop and go events (in the second dataset) happen closer and closer (in time and position) to the red/green light events (in the first dataset). Similarly for a train—the accelerometer in a mobile device might detect the initial braking towards arriving at a station (as recorded in the second dataset) so a known offset and/or error window may be applied to correlate with the actual stop event (e.g. as captured by proximity/presence sensors within the station which generate the first dataset).

The correlation (in block 206) may be performed in real-time, with the data points being received in real-time from both the infrastructure and the mobile device 108. In this way, the location which is determined (and output in block 208) is a current or most recent location. Alternatively, the correlation may be performed offline (i.e. not in real-time) to determine a location path or a historic location (i.e. a location at some time in the past) for the mobile device (and, in various examples, the user carrying the mobile device). Where the correlation is not performed in real-time, one or both of the datasets may still be received in real-time or alternatively, one or both of the datasets may be stored by the mobile device and/or infrastructure and then provided to the system in order to perform the offline correlation.

The location determining method described above may be the sole location determining method that is used or is capable of being used by the mobile device 108 (e.g. where the mobile device does not have GPS capability). In other examples, however the method described above may be used in combination with, although not at the same time as, other known methods of determining the location of a mobile device (e.g. using GPS, or based on the cell-tower or access point the device is connected to). In various examples, a mobile device may use a first location technique which relies upon receiving wireless signals (e.g. GPS signals, WiFiTM beacons, etc.) when the battery level is above a threshold value and may switch to the method described herein when the battery level is below the threshold value (‘Yes’ in block 210 in FIG. 2). In various examples, a mobile device may use the method described herein to identify the location of the mobile device (and hence a user in those examples where the user is carrying the mobile device) unless the uncertainty in the resultant location (as output in block 208) exceeds a threshold value or falls outside pre-defined limits (‘No in block 212 in FIG. 2) and then another location technique (e.g. using GPS, WiFi™ base stations or cell towers) may be automatically enabled (block 214) e.g. the GPS receiver in the mobile device may be switched on. As described above, the resultant location is generated based on the correlation performed (in block 206) and may also, in various examples, rely upon an extrapolation (in block 207) from the initial output location generated using the correlation. Where extrapolation is used, the uncertainty in the resultant location (which is assessed in block 212) is caused, at least partially, by the extrapolation process.

In a first example implementation scenario, the infrastructure is a transportation system (e.g. a bus or train system, where the trains may be overground or underground) and the infrastructure elements are stops/stations within the transportation system. The first time series dataset is generated by sensors (e.g. track-based or train-based sensors) at the stops/stations (i.e. at each infrastructure element) within the transportation system (e.g. on a bus stop, platform or rail) which detect the presence/absence of transportation vehicles (e.g. a train or bus) and each data point may identify whether a transportation vehicle is present or absent. There may also be sensors at other locations (e.g. in tunnels, at major road intersections, etc.) and these are further infrastructure elements. As described above, the infrastructure dataset (the first dataset) may comprise regularly spaced data points (e.g. which indicate the presence or absence of a transportation vehicle at a particular infrastructure element at the point in time identified by the timestamp) or irregularly spaced data points (e.g. which indicate the arrival and/or departure of a transportation vehicle at a particular infrastructure element at the point in time identified by the timestamp). The first (infrastructure) dataset may be collated into the dataset either by an element within the infrastructure or on input to the location system (e.g. separate computing device 112). An example of the resulting dataset may be a list of arrival times and departure times of trains at stations, which is data that may often be made available by train operating companies e.g. via their website or mobile apps to assist users. The second (mobile device) time series dataset may be generated using an accelerometer within the mobile device 108.

In this first example, the correlation engine 118 correlates the presence/absence of the transportation vehicles (as captured by the first dataset) against the motion of the mobile device (as captured by the second dataset) and from this can determine which transportation vehicle the mobile device is travelling on. For example, even if multiple transportation vehicles depart from the same or different infrastructure elements at the same time such that there are multiple infrastructure data points indicating the departure of a transportation vehicle at a first time t₁ which correspond to a single mobile device data point (also at t₁) indicating acceleration/motion, by correlating multiple data points, a path taken by the mobile device can be identified as the transportation vehicles will not all arrive at and leave from infrastructure elements at the same time over a period time. In this example, the location which is output (in block 208) may be a location path corresponding to the infrastructure elements for each correlated data point in time order.

The first example described a system which tracks the locations of mobile devices traveling on a transportation system (e.g. on a bus, train, tram, etc.); however, the system may also be used to determine the location of a mobile device, and hence a user carrying the mobile device, who is travelling on foot or in another type of vehicle (e.g. bicycle, taxi, personal car). In a second example implementation scenario, the infrastructure is a traffic light system and the first (infrastructure-related) time series dataset describes the dynamic events when each traffic light changes color (e.g. from red to green and vice versa). As in the first example, the second (mobile device) time series dataset may be generated using an accelerometer within the mobile device 108.

In this second example, the correlation engine 118 correlates the motion of the mobile device (e.g. when it starts/stops) as captured by the second dataset against the traffic light state as captured by the first dataset. As described above, this is an example where some mapping may need to be applied, as a mobile device may not stop exactly at the same time as the traffic light turns red (e.g. because the vehicle containing the mobile device has not quite reached the stop line) and a mobile device may not start exactly when the traffic light turns green (e.g. because it is in a vehicle which is second in the queue and must wait for the vehicle in front to move off first).

In a third example, which also relates to a transportation system, the infrastructure elements are vehicles (e.g. buses) and the first (infrastructure) dataset records the revolutions of the engine (e.g. as determined by the tachometer in the vehicle). The second (mobile device) dataset is generated using a microphone in the mobile device 108 which records the noise of the engine. In this third example, the correlation engine 118 correlates the revolutions/minute of the vehicle (in the first dataset) with the engine volume (in the second dataset) and from this can determine which transportation vehicle the mobile device is travelling on (e.g. as in the first example above).

The three examples above describe transportation systems within a wide area (e.g. within a town or city); however, the system may also be used on a smaller scale, such as within a building. In a fourth example implementation scenario, the infrastructure is a lighting system within a building and the first (infrastructure-related) time series dataset describes when lights are switched on in different rooms in the building. The first time series dataset is not generated based on light-sensors in each room (i.e. it does not record light levels) but instead is generated by detecting when light switches are activated by users or based on power/current drawn by light fixtures and hence records electricity use. As such, the infrastructure elements may be the individual light fixtures or parts of the building (e.g. a room or a corridor) depending upon the granularity of the available data which is used to generate the first time series dataset. The second (mobile device) time series dataset may be generated using a light sensor within the mobile device 108.

In this fourth example, the correlation engine 118 correlates light levels detected by the light sensor on the mobile device (as recorded in the second dataset) against the known state of the lighting fixtures in the building (as recorded by the first dataset).

In a fifth example, the first (infrastructure) dataset may record the positions of elevators in a building (e.g. which floor they are stopped at) and the second (mobile device) dataset may be generated by a barometric sensor in the mobile device.

In a sixth example, the second (mobile device) dataset may sense the music being played in a shop or room and then use a service to identify the particular piece of music. This may then be compared to a first (infrastructure) dataset which comprises a playlist of what is actually played in each shop/room (e.g. as generated by one or more media players in real-time when they switch tracks, rather than a ‘scheduled’ playlist, which may not accurately represent what was actually played due to user intervention, insertion of adverts, etc.).

As described above, the location of a mobile device (and hence, in various examples, a user) is determined using a mobile device time series dataset (the second dataset) and an infrastructure-related time series dataset (the first dataset). Where the mobile device is carried by a user, the mobile device time series dataset (the second dataset) may alternatively be referred to as a personal time series dataset. Many mobile devices/users can use this method to track their location by generating their own mobile device (or personal) time series datasets (on their own mobile device) and comparing their dataset against the same infrastructure-related time series dataset. This provides a system which is both scalable to very large numbers of mobile devices/users and more secure because the infrastructure is not tracking individual mobile devices/users but the operation of the infrastructure itself and users can control when and how their mobile device (or personal) time series dataset is generated, stored and used. Furthermore, as the operator of the infrastructure is likely to be generating the infrastructure-related time series dataset (the first dataset) for other purposes (e.g. monitoring the performance of the infrastructure, fault detection, providing user information, etc.), the system may be implemented without any additional data capture by the infrastructure operator.

As the mobile device dataset is generated using sensors within the mobile device, the method can be implemented on devices which do not have any network connectivity (e.g. in addition to not relying upon GPS capability, the method does not rely upon the availability of wired or wireless network connectivity to generate the mobile device dataset). A user can still determine their historic location or location path by generating and storing the personal (second) dataset on their mobile device which they are carrying and then subsequently inputting the dataset to the location system. Similarly, the historic locations or location paths of many mobile devices which are not carried by users can be determined by generating and storing a mobile device (second) dataset on each mobile device and subsequently inputting these datasets to the location system. This method can, therefore be used to generate location paths over long periods of time (e.g. over several days) using mobile devices with very low power consumption (e.g. a mobile phone or wearable device that has been placed in flight-safe mode). The method additionally provides a low power method of real-time localization as described above.

The method described herein may involve the observation of a user through the generation of the second (personal) time series dataset on a mobile device that the user is carrying. Accordingly, the method presented herein is fully compatible with opt-in participation of the persons being observed. In embodiments where the personal dataset is collected on the mobile device and transmitted to a remote and shared computing device (e.g. separate computing device 112 where this is located in a data center) where the correlation is performed, that data can be anonymized in a known manner and/or maintained within a secure personal cloud. In other embodiments, the personal dataset may be confined to the mobile device (which may therefore perform the correlation using a first (infrastructure) dataset received from an external source or may be uploaded, by the user, to a separate computing device 112 to perform the location determination, where this separate computing device is a second computing device owned by the user (e.g. a desktop, laptop or tablet computer or games console).

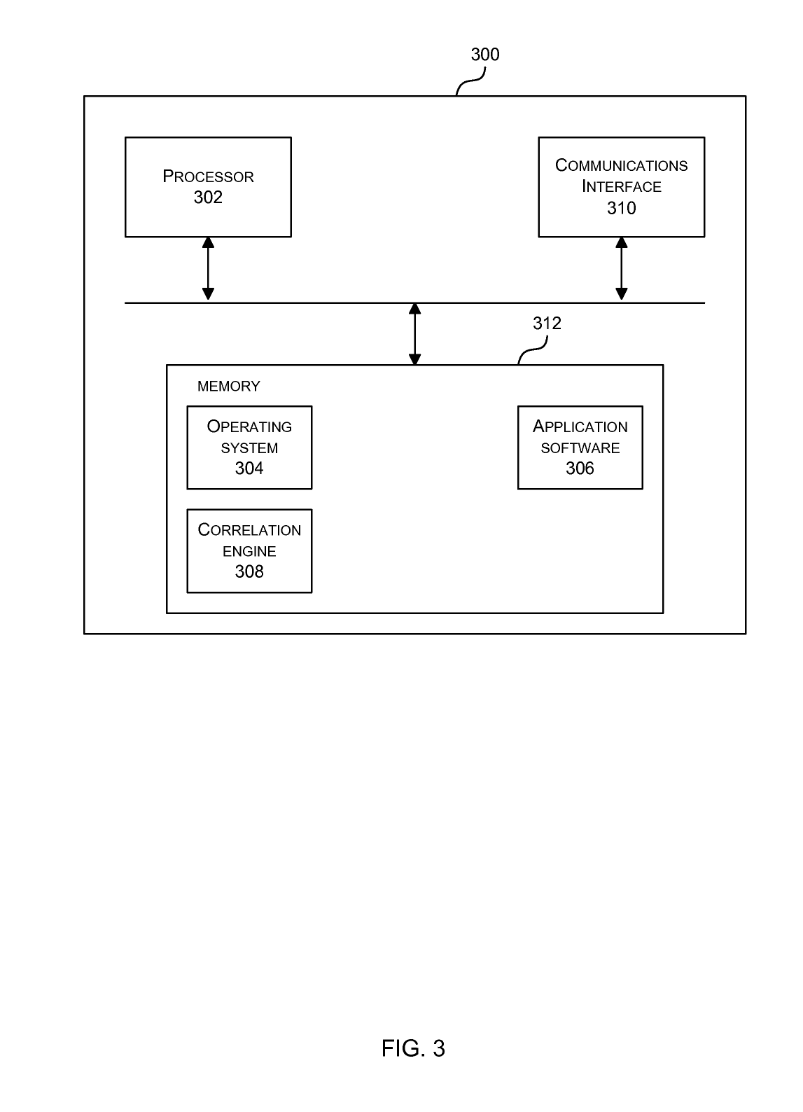

FIG. 3 illustrates various components of an exemplary computing-based device 300 which may be implemented as any form of a computing and/or electronic device, and in which the location determining method described above may be implemented. This computing-based device 300 may be a mobile device or a separate computing device which implements the location determining method using a dataset generated using a sensor in a mobile device. As described above, the separate computing device may be a shared device (e.g. located in a data center) or a personal computing device (e.g. a user's desktop, laptop or tablet computer or games console).

Computing-based device 300 comprises one or more processors 302 which may be microprocessors, controllers or any other suitable type of processors for processing computer executable instructions to control the operation of the device in order to perform the location determining method described above. In some examples, for example where a system on a chip architecture is used, the processors 302 may include one or more fixed function blocks (also referred to as accelerators) which implement a part of the method of location determination (e.g. the correlation engine 118) in hardware logic components (rather than software or firmware). For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Platform software comprising an operating system 304 or any other suitable platform software may be provided at the computing-based device to enable application software 306 and the correlation engine 308 to be executed on the device. As described above, the correlation engine 308 may output the location information (in block 208) to the application software 306 or to applications/services running on different computing-based devices (e.g. via the communications interface 310).

The computer executable instructions may be provided using any computer-readable media that is accessible by computing based device 300. Computer-readable media may include, for example, computer storage media such as memory 312 and communications media. Computer storage media, such as memory 312, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 312) is shown within the computing-based device 300 it will be appreciated that the storage may be distributed or located remotely and accessed via a network or other communication link (e.g. using communication interface 310).

The computing-based device 300 also comprises a communication interface 310 which acts as an input for receiving the first and/or second datasets (i.e. it acts as the first and/or second inputs 114, 116). In examples where the computing-based device 300 is the mobile device 108 comprising the sensor 110 which generates the second (mobile device) dataset, the second input 116 may be internal to the computing-based device 300 and receive the dataset from the sensor 110 for input to the correlation engine 308.

The computing-based device 300 may also comprises an input/output controller (not shown in FIG. 3) arranged to output display information to a display device which may be separate from or integral to the computing-based device. The display information may provide a graphical user interface (e.g. to display the location information output in block 208). The input/output controller may also be arranged to receive and process input from one or more devices, such as a user input device (e.g. a mouse, keyboard, camera, microphone or other sensor). In some examples the user input device may detect voice input, user gestures or other user actions and may provide a natural user interface (NUI). In an embodiment the display device may also act as the user input device if it is a touch sensitive display device. The input/output controller may also output data to devices other than the display device, e.g. a locally connected printing device.

Any of the input/output controller, display device and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a public infrastructure system (such as a transportation system), the system described is provided as an example and not a limitation. As those skilled in the art will appreciate, the present examples are suitable for application in a variety of different types of infrastructures, e.g. public or private infrastructure systems.

A first further example provides a system for determining a location of a mobile device, the system comprising: a first input configured to receive a first time series dataset, the first data time series dataset recording dynamic events in an infrastructure; a second input configured to receive a second time series dataset, the second time series dataset having been generated by a sensor in a mobile device; and a correlation engine configured to determine the location of the mobile device by correlating two or more data points from the first dataset with two or more data points from the second dataset.

The system may be arranged to determine the location of a user carrying the mobile device and the mobile device may be a personal computing device or a personal electronic device.

A second further example provides a system for determining a location of a user, the system comprising: a first input configured to receive a first time series dataset, the first data time series dataset recording dynamic events in an infrastructure; a second input configured to receive a second time series dataset, the second time series dataset having been generated by a sensor in a personal computing device carried by the user; and a correlation engine configured to determine the location of the user by correlating two or more data points from the first dataset with two or more data points from the second dataset.

The system of the first or second further examples may further comprise: an output configured to provide the location to an application or service providing location-based features.

The infrastructure may comprise a plurality of physically separated infrastructure elements and wherein the first time series dataset comprises one or more data points recording dynamic events at one or more of the infrastructure elements.

A data point in the first time series dataset may comprise a timestamped data value, wherein the data value is a measurement of a parameter at one of the infrastructure elements.

A data point in the first time series dataset may comprise a timestamped data value, wherein the data value identifies a current state of one of the infrastructure elements.

A data point in the first time series dataset may further comprise an identifier for the infrastructure element to which the data point relates.

The first and second time series datasets may record different physical phenomenon.

The correlation engine may be configured to use an application-specific mapping when correlating two or more data points from the first dataset with two or more data points from the second data set.

The system of the first or second further examples may implemented within the mobile device and/or the system may further comprise the mobile device in the case of the first further example (e.g. the mobile device as set out in the third further example below) or the personal computing device (e.g. the personal computing device as set out in the fourth further example below).

A third further example provides a mobile device comprising: a sensor arrangement configured to generate a second time series dataset in a first mode of operation; an output configured, in the first mode of operation, to output the second time series dataset to a correlation engine for use in determining a location of the mobile device; and an input configured, in the first mode of operation, to receive location data generated by the correlation engine using the second time series dataset and a first time series dataset, the first time series dataset recording dynamic events in an infrastructure.

A fourth further example provides a personal computing device comprising: a sensor arrangement configured to generate a second time series dataset in a first mode of operation; an output configured, in the first mode of operation, to output the second time series dataset to a correlation engine for use in determining a location of the personal computing device; and an input configured, in the first mode of operation, to receive location data generated by the correlation engine using the second time series dataset and a first time series dataset, the first time series dataset recording dynamic events in an infrastructure.

The device of the third or fourth further example may further comprise the correlation engine and an input configured to receive a first time series dataset, the first data time series dataset recording dynamic events in an infrastructure, wherein the correlation engine is configured to determine the location of the mobile device by correlating two or more data points from the first dataset with two or more data points from the second dataset.

The device of the third or fourth further example may further comprise: a GPS receiver configured to generate location data in a second mode of operation; and a battery, and wherein the device is configured to switch from the second mode of operation to the first mode of operation in response to a power level of the battery falling below a threshold value.

The device of the third or fourth further example may not include a GPS receiver.

The sensor in the device of the third or fourth further example may be an accelerometer.

A mobile device of the third further example may be a personal computing device.

A fifth further example provides a method of determining a location of a mobile device (or a user, where the user carries the mobile device), the method comprising: receiving, at a computing device, a first time series dataset, the first data time series dataset recording dynamic events in an infrastructure; receiving, at a computing device, a second time series dataset, the second time series dataset having been generated by a sensor in a mobile device; and correlating, in a correlation engine, two or more data points from the first dataset with two or more data points from the second dataset to determine a location of the mobile device.

The method may further comprise: comparing an error associated with the determined location to a pre-defined error limit; and in response to determining that the error exceeds the pre-defined error limit, automatically enabling hardware in the mobile device which is configured to perform location determination using an alternative technique.

The hardware configured to perform location determination using an alternative technique may be a GPS receiver.

The method may further comprise: comparing a power level of a battery in the mobile device to a pre-defined power limit; and in response to determining that the power level is below the pre-defined power limit, automatically disabling hardware in the mobile device which is configured to perform location determination using an alternative technique and enabling location determination by the correlation engine.

The method may further comprise: providing the location data for the user to an application running on the mobile device.

A sixth further example provides a system for determining a location of a mobile device (or a user, where the user carries the mobile device), the system comprising: means for receiving a first time series dataset, the first data time series dataset recording dynamic events in an infrastructure; means for receiving a second time series dataset, the second time series dataset having been generated by a sensor in a mobile device; and means for determining the location of the mobile device by correlating two or more data points from the first dataset with two or more data points from the second dataset.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A system for determining a location of a mobile device, the system comprising:
a communication interface configured to receive from a data collator a first time series dataset, the first time series dataset indicating events in an infrastructure that are detected by a sensor located within elements of the infrastructure;
the communication interface further configured to receive from the mobile device a second time series dataset, the second time series dataset having been generated by a sensor in a mobile device; and
a correlation engine configured to determine the location of the mobile device by correlating two or more data points from the first time series dataset with two or more data points from the second time series dataset.

2. A system according to claim 1 arranged to determine the location of a user carrying the mobile device and wherein the mobile device is a personal computing device or a personal electronic device.

3. A system according to claim 1, further comprising:
an output configured to provide the location to an application or service providing location-based features.

4. A system according to claim 1, wherein the infrastructure comprises a plurality of physically separated infrastructure elements and wherein the first time series dataset comprises one or more data points recording dynamic events at one or more of the infrastructure elements.

5. A system according to claim 4, wherein a data point in the first time series dataset comprises a timestamped data value, wherein the data value is a measurement of a parameter at one of the infrastructure elements or the data value identifies a current state of one of the infrastructure elements.

6. A system according to claim 4, wherein a data point in the first time series dataset further comprises an identifier for the infrastructure element to which the data point relates.

7. A system according to claim 1, wherein the first and second time series datasets record different physical phenomenon.

8. A system according to claim 1, wherein the correlation engine is configured to use an application-specific mapping when correlating two or more data points from the first dataset with two or more data points from the second data set.

9. A system according to claim 1, wherein the system is implemented within the mobile device.

10. A mobile device comprising:
a sensor arrangement configured to generate a second time series dataset in a first mode of operation;
a communication interface configured, in the first mode of operation, to output the second time series dataset to a correlation engine for use in determining a location of the mobile device; and
the communication interface configured an input configured, in the first mode of operation, to receive location data generated by the correlation engine using the second time series dataset and a first time series dataset, the first time series dataset recording dynamic events in an infrastructure.

11. A mobile device according to claim 10, further comprising the correlation engine and an input configured to receive a first time series dataset, the first data time series dataset recording dynamic events in an infrastructure, wherein the correlation engine is configured to determine the location of the mobile device by correlating two or more data points from the first dataset with two or more data points from the second dataset.

12. A mobile device according to claim 10, further comprising:
a GPS receiver configured to generate location data in a second mode of operation; and
a battery,
and wherein the mobile device is configured to switch from the second mode of operation to the first mode of operation in response to a power level of the battery falling below a threshold value.

13. A mobile device according to claim 10, wherein the mobile device does not include a GPS receiver.

14. A mobile device according to claim 10, wherein the sensor is an accelerometer.

15. A mobile device according to claim 10, wherein the mobile device is a personal computing device.

16. A method of determining a location of a mobile device, the method comprising:
receiving, at a computing device, a first time series dataset, the first data time series dataset indicating dynamic events in an infrastructure, the first data time series including at least one of: (i) a measurement of an element of the infrastructure by a sensor in the element of the infrastructure or (ii) a state identifier identifying a current state of the element of the infrastructure;
receiving, at a computing device, a second time series dataset, the second time series dataset having been generated by a sensor in a mobile device; and
correlating, in a correlation engine, two or more data points from the first dataset with two or more data points from the second dataset to determine a location of the mobile device.

17. A method according to claim 16, further comprising:
comparing an error associated with the determined location to a pre-defined error limit; and
in response to determining that the error exceeds the pre-defined error limit, automatically enabling hardware in the mobile device which is configured to perform location determination using an alternative technique.

18. A method according to claim 17, wherein the hardware configured to perform location determination using an alternative technique is a GPS receiver.

19. A method according to claim 16, further comprising:
comparing a power level of a battery in the mobile device to a pre-defined power limit; and
in response to determining that the power level is below the pre-defined power limit, automatically disabling hardware in the mobile device which is configured to perform location determination using an alternative technique and enabling location determination by the correlation engine.

20. A method according to claim 16, further comprising:
providing the location data for the user to an application running on the mobile device.
